(19) United States
(12) Patent Application Publication
(10) Pub. No.: US 2026/0134778 A1
(43) Pub. Date: May 14, 2026

(54) ATTENTION ATTRACTING DEVICE AND ATTENTION ATTRACTING METHOD

(71) Applicant: HONDA MOTOR CO., LTD., Tokyo (JP)

(72) Inventors: Haruko Okuyama, Wako-shi (JP); Tatsuya Iwasa, Wako-shi (JP); Tsuyoshi Nojiri, Wako-shi (JP); Toshihiro Hashimoto, Wako-shi (JP); Yuichiro Shimura, Wako-shi (JP)

(21) Appl. No.: 19/369,443

(22) Filed: Oct. 27, 2025

(30) Foreign Application Priority Data
Nov. 14, 2024 (JP) 2024-198765

(51) Int. Cl. G08G 1/16; G06F 3/01; G06F 3/16

(52) U.S. Cl. CPC G08G 1/16; G06F 3/011; G06F 3/016; G06F 3/167

(57) ABSTRACT

An attention attracting device includes: a notification determination unit, when a target object whose risk index value is within a setting range is detected, determining types of notification to a driver and a level of notification for each type of notification, based on the risk index value; and a notification execution unit notifying the driver, the notification determination unit determining, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

### INCORPORATION BY REFERENCE

The present application claims priority under 35 U.S.C. § 119 to Japanese Patent Application No. 2024-198765 filed on Nov. 14, 2024. The content of the application is incorporated herein by reference in its entirety.

### BACKGROUND OF THE INVENTION

### FIELD OF THE INVENTION

The present invention relates to an attention attracting device and an attention attracting method.

### Description of the Related Art

In recent years, systems have been known in which a plurality of human machine interface (HMI) devices notify a driver of a vehicle of risks.

For example, Japanese Patent Laid-Open No. 2013-171391 discloses a vehicle vicinity monitoring system including a first device that provides information on a direction of an approaching object at least by a voice output and a second device that provides information on a direction of an approaching object at least by a display.

In addition, Japanese Translation of PCT International Application Publication No. 2007-528996 discloses a display and instruction method of displaying a danger warning and outputting a voice issuing the danger warning.

However, when there are a plurality of targets present to be notified to a driver of a vehicle, there is a problem that it is difficult to notify the driver of a specified target to be notified. The present application aims to improve visibility in order to solve the above problem. In addition, the present application aims to further improve traffic safety and contribute to development of a sustainable transportation system.

### SUMMARY OF THE INVENTION

An aspect of the present invention provides an attention attracting device including: an index value acquisition unit that acquires, based on outputs of a plurality of sensors mounted on a vehicle, a risk index value indicating a collision risk with a target object present in front of the vehicle; a determination unit that, when a target object is detected of which the acquired risk index value is within a setting range set in advance, determines types of notification to be notified to a driver of the vehicle by an HMI device and a level of notification for each of the types of notification, based on the risk index value; and a notification execution unit that causes the HMI device corresponding to the type of notification determined by the determination unit to notify the driver of the vehicle at the level of notification determined by the determination unit, the determination unit being configured to determine, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

In another aspect of the present invention, the determination unit is configured to: detect, as the plurality of target objects, a first target object with the risk index value within the setting range and a second target object with the risk index value within the setting range, the risk index value being smaller than the risk index value of the first target object; and when the risk index value of the first target object falls below the setting range, change the level of notification of any one of types of notification for the first target object to be high or low, and then allow the HMI device to stop the notification for the first target object.

In another aspect of the present invention, the determination unit is configured to: detect, as the plurality of target objects, a first target object with the risk index value within the setting range and a second target object with the risk index value within the setting range, the risk index value being smaller than the risk index value of the first target object; and when the risk index value of the first target object falls below the setting range, change a level of a first type of notification among types of notifications used for the notification for the first target object to be high, change a level of a second type of notification different from the first type to be low, and then allow the HMI device to stop the notification for the first target object.

In another aspect of the present invention, the HMI device includes a visual HMI device, the determination unit is configured to determine a value of a visual parameter for changing an image displayed by the visual HMI device from the level of notification determined based on the risk index value, and the visual parameter includes a parameter for changing at least one of enlargement and reduction of the image, a display area of the image, display luminance of the image, a display color of the image, a shape of the image, and a blinking cycle of the image.

In another aspect of the present invention, the HMI device includes an auditory HMI device, the determination unit is configured to determine a value of an auditory parameter for changing a voice output by the auditory HMI device from the level of notification determined based on the risk index value, and the auditory parameter includes a parameter for changing at least one of a playback speed or a playback cycle, a volume of sound, and a voice pitch of voice data which is a source of the voice.

In another aspect of the present invention, the HMI device includes a tactile HMI device, the determination unit is configured to determine a value of a tactile parameter for changing a level of vibration output by the tactile HMI device from the level of notification determined based on the risk index value, and the tactile parameter includes a parameter for changing at least one of a period of the vibration, an amplitude of the vibration, and a waveform of the vibration.

Another aspect of the present invention provides an attention attracting method of causing a processor of an attention attracting device mounted on a vehicle to execute: an acquisition step of acquiring, based on outputs of a plurality of sensors mounted on a vehicle, a risk index value indicating a collision risk with a target object present in front of the vehicle; a determination step of, when a target object is detected of which the acquired risk index value is within a setting range set in advance, determining types of notification to be notified to a driver of the vehicle by an HMI device and a level of notification for each of the types of notification, based on the risk index value; and a notification step of causing the HMI device corresponding to the type of notification determined in the determination step to notify the driver of the vehicle at the level of notification determined in the determination step, the determination step including determining, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

According to an aspect of the present invention, when there are a plurality of target objects to be notified are detected, it is possible to notify a driver of the presence of the plurality of target objects and to allow the driver to recognize a target object that requires the most attention by providing different levels of notification.

### BRIEF DESCRIPTION OF THE DRAWINGS

FIG. 1 is a diagram illustrating a configuration of a control system of a vehicle;

FIG. 2 is a view illustrating a configuration of a vehicle interior of the vehicle;

FIG. 3 is a diagram illustrating an example of a first setting table;

FIG. 4 is a diagram illustrating an example of a second setting table;

FIG. 5 is a diagram illustrating another example of the second setting table;

FIG. 6 is a view illustrating a first output example of an HMI device;

FIG. 7 is a view illustrating a second output example of the HMI device;

FIG. 8 is a view illustrating a third output example of the HMI device;

FIG. 9 is a view illustrating a fourth output example of the HMI device; and

FIG. 10 is a flowchart illustrating an operation of an attention attracting device.

### DETAILED DESCRIPTION OF THE INVENTION

### 1. Configuration of Vehicle

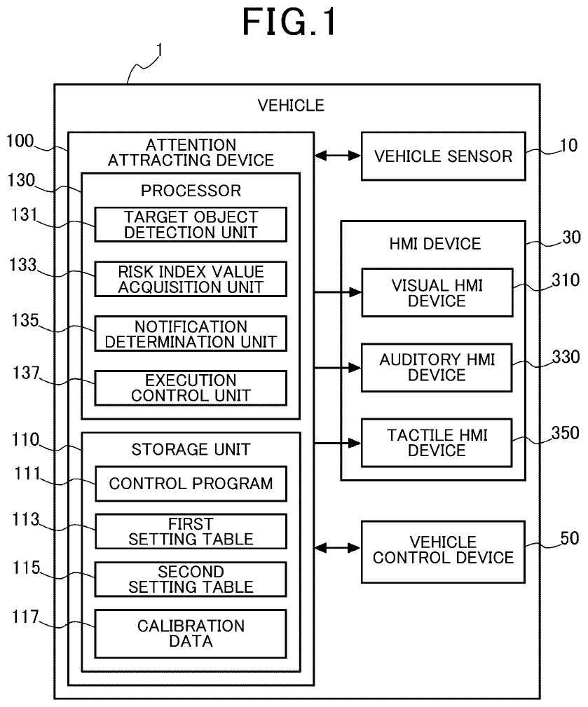

FIG. 1 is a diagram illustrating a configuration of a vehicle 1.

The vehicle 1 is mounted with a vehicle sensor 10, an HMI device 30, a vehicle control device 50 (computer), and an attention attracting device 100.

The vehicle sensor 10 includes at least one of one or more cameras, radar, lidar, and sonar distributed to a body of the vehicle 1, and detects target objects present around the vehicle 1. The vehicle sensor 10 outputs data measured by the cameras, radar, lidar, or sonar to the attention attracting device 100, as sensor data.

The HMI device 30 includes a visual HMI device 310 that outputs visual information, an auditory HMI device 330 that outputs sound as an auditory stimulus to a driver, and a tactile HMI device 350 that provides a stimulus to a driver's tactile sense.

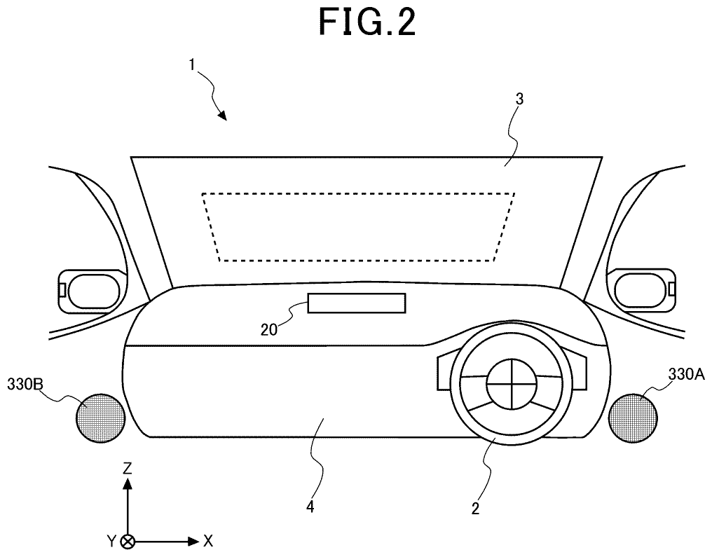

FIG. 2 is a view illustrating a configuration of a vehicle interior of the vehicle 1. An X-axis, a Y-axis, and a Z-axis illustrated in FIG. 2 and FIGS. 5 and 6 to be described below are orthogonal to each other. The Z-axis indicates an up-down direction. The X-axis and the Y-axis are parallel to a horizontal direction when the vehicle 1 is traveling. The X-axis indicates a left-right direction as a vehicle width direction. The Y-axis indicates a front-rear direction. A positive direction of the X-axis indicates a right direction. A positive direction of the Y-axis indicates a front direction. A positive direction of the Z-axis indicates an up direction.

In the present embodiment, the visual HMI device 310 is a head-up display provided in an instrument panel 4 of the vehicle 1. The head-up display notifies the driver of the presence of a target object that may cause a collision by displaying an image on a windshield 3 as a projection surface. The driver sitting in a driver's seat can view the image through the windshield 3 along with a scene ahead of the vehicle 1.

In the present embodiment, the auditory HMI device 330 is a speaker. FIG. 2 illustrates a speaker 330A provided on the driver's seat side of the vehicle 1 and a speaker 330B provided on a passenger seat side, as an auditory HMI device 330.

In the present embodiment, the tactile HMI device 350 is a device that vibrates the driver's seat of the vehicle 1. The tactile HMI device 350 includes, for example, a vibration motor that generates vibrations in the seat in which the driver sits, and drives the vibration motor based on a vibration control signal input from the attention attracting device 100. Thus, a tactile stimulus is provided to the driver. The tactile HMI device 350 may be an electric seat belt that changes tension of the seat belt to provide a tactile stimulus to the driver.

### 2. Configuration of Attention Attracting Device

The attention attracting device 100 is configured by an ECU or a computer including a storage unit 110, a processor 130, an input/output interface (not illustrated), and the like.

The storage unit 110 includes, for example, a non-volatile RAM (Read Only Memory), or ROM and RAM (Random Access Memory). The storage unit 110 may include an auxiliary storage device such as an SSD (Solid State Drive) or an HDD (Hard Disk Drive).

The storage unit 110 stores a control program 111 executed by the processor 130, a first setting table 113, a second setting table 115, and calibration data 117.

The first setting table 113 and the second setting table 115 are used to determine, when the attention attracting device 100 notifies the driver of the presence of the target object, a type of the HMI device 30 to be used for the notification and a level of the notification to be notified by the HMI device 30. The first setting table 113 and the second setting table 115 will be described in detail below.

The calibration data 117 is conversion data for converting a position of the target object obtained by image analysis of an image captured by a camera in the vehicle sensor 10 into a display position when the image is displayed on the windshield 3 by the head-up display. The calibration data 117 is registered in advance in the storage unit 110 when the camera is installed.

The processor 130 is an arithmetic processing device including a processor such as a CPU (Central Processing Unit) or an MPU (Micro-Processing Unit). The processor 130 may be configured with a single processor, or may be configured with a plurality of processors. In addition, the processor 130 may also be configured with an SoC integrated with part or all of the storage unit 110 or other circuits. The processor 130 may also be configured with a combination of a CPU that executes a program and a DSP (Digital Signal Processor) that executes predetermined arithmetic processing. Furthermore, the processor 130 may have a configuration in which all of functions are implemented in hardware or a configuration using a programmable device.

The attention attracting device 100 includes, as functional units, a target object detection unit 131, a risk index value acquisition unit 133, a notification determination unit 135, and a notification execution unit 137. These functional units are implemented by the processor 130 that executes the control program 111 stored in the storage unit 110. The risk index value acquisition unit 133 corresponds to an index value acquisition unit, and the notification determination unit 135 corresponds to a determination unit.

The target object detection unit 131 detects, based on the sensor data input from the vehicle sensor 10, target objects present around the vehicle 1. The target objects are objects that may collide with or come into contact with the vehicle 1, and need to be notified the driver of the vehicle 1 of the presence thereof. Examples of the target objects to be detected by the target object detection unit 131 include pedestrians, other vehicles, and stationary objects such as walls or utility poles. The target object detection unit 131 of the present embodiment detects, as a target object, an object that is present ahead of the vehicle 1 in a traveling direction and may come into contact with or collide with the vehicle 1. In other words, the target object detection unit 131 detects a target object present ahead of the vehicle 1 when the vehicle 1 travels forward, and detects a target object present behind the vehicle 1 when the vehicle 1 travels backward. The target object detection unit 131 detects a position, a moving speed, and a moving direction of the detected target object. The target object detection unit 131 outputs information indicating the position, the moving speed, and the moving direction of the detected target object to the risk index value acquisition unit 133.

The target object detection unit 131 may detect a target object or a relative position of the target object using a vehicle-to-vehicle communication device, a GNSS (Global Navigation Satellite Systems) unit, or a V2X (Vehicle-to-Everything) communication device or the like in addition to the sensor such as a front camera provided in the vehicle sensor 10. The target object detection unit 131 may also detect a target object appearing in a captured image or a relative position of the target object, using a determination in a virtual environment via a server. Communication partner in the VX2 communication includes other vehicles, pedestrians, networks, and infrastructures, for example.

The risk index value acquisition unit 133 receives, as an input, the information indicating the position, the moving speed, and the moving direction of the target object detected by the target object detection unit 131. In addition, the risk index value acquisition unit 133 receives, as an input, sensor data such as an image captured by the camera.

For example, the risk index value acquisition unit 133 predicts a moving line between the target object and the vehicle 1, based on the position, the moving direction, and the moving speed of the target object, the position, the moving direction, and the moving speed of the vehicle 1, a lighting state of traffic lights detected from the image captured by the camera, and the like. The risk index value acquisition unit 133 calculates a risk index value based on a position where the vehicle 1 and the target object are closest to each other, and a distance between the vehicle 1 and the target object at the position. The risk index value is a value indicating the possibility of contact or collision between the vehicle 1 and the target object. The risk index value is obtained by, for example, scoring the position, the moving direction, and the moving speed of the target object, and the distance between the vehicle 1 and the target object, and then multiplying the scored values by a weighting coefficient to calculate the sum of the resulting values.

During a prediction of a moving line of the target object, when the target object is a vehicle, the risk index value acquisition unit 133 may take into consideration lighting states of turn signal lights and a brake light of the vehicle, and when the target object is a pedestrian, the risk index value acquisition unit 133 may take into consideration an orientation of a face of the pedestrian. Similarly, during a prediction of a moving line of the vehicle 1, the risk index value acquisition unit 133 may take into consideration lighting states of turn signal lights and a brake light of the vehicle 1 obtained from the vehicle sensor 10, and may take into consideration the route being guided if a navigation device (not illustrated) is guiding the route.

In addition, the risk index value acquisition unit 133 detects a risk of contact between the vehicle 1 and a target object actually detected in an environment surrounding the vehicle 1, and may also infer and detect a risk of contact with a target object (such as a virtual vehicle or a pedestrian) that has not yet been detected, but can appear based on visibility, the number of accidents, and the like at an intersection or the like. The risk index value acquisition unit 133 outputs the risk index value for each of the target objects to the notification determination unit 135.

The risk index value for each target object is input to the notification determination unit 135 from the risk index value acquisition unit 133. The notification determination unit 135 determines, based on the risk index value to be input, whether there is a target object to be notified. When there is the target object to be notified, the notification determination unit 135 determines a type of notification and a level of notification to the driver. The type of notification indicates a type of the HMI device 30 used to notify the driver. The level of notification is, for example, a size and luminance of a figure displayed by the visual HMI device 310, a volume of the sound output by the auditory HMI device 330, and a level of the vibration output by the tactile HMI device 350.

First, the notification determination unit 135 compares the risk index value input from the risk index value acquisition unit 133 with a first threshold value set in advance to detect a target object having a risk index value equal to or greater than the first threshold value. The target object having the risk index value equal to or greater than the first threshold value corresponds to a target object having a risk index value within a setting range set in advance.

In addition, when detecting the target object having the risk index value equal to or greater than the first threshold value, the notification determination unit 135 determines whether the number of detected target objects is one.

### 3. Case of Detecting One Target Object

First, a case will be described in which the number of target objects to be notified is one.

When the number of target objects having the risk index value equal to or greater than the first threshold value set in advance is one, the notification determination unit 135 determines, based on the risk index value of the detected target object, the type of notification and the level of notification. For example, the range of the risk index value equal to or greater than the first threshold value is divided into a plurality of ranges, for example, a first range, a second range, a third range, a fourth range, and a fifth range. The notification determination unit 135 may determine the type of notification and the level of notification by determining the range in which the detected risk index value equal to or greater than the first threshold value falls. The first range is a range equal to or greater than the first threshold value and less than a second threshold value. The second range is a range equal to or greater than the second threshold value and less than a third threshold value. The third range is a range equal to or greater than the third threshold value and less than a fourth threshold value. The fourth range is a range equal to or greater than the fourth threshold value and less than a fifth threshold value. The fifth range is a range that coincides with the fifth threshold value.

### 4. Case of Detecting Plurality of Target Objects

Next, a case will be described in which the number of target objects to be notified is many.

When a plurality of target objects having the risk index value equal to or greater than the first threshold value are detected, the notification determination unit 135 determines the type of notification and the level of notification for each of the plurality of target objects.

First, the notification determination unit 135 specifies a target object with the highest risk index value among the detected target objects. Such a target object is referred to as a first target object. The notification determination unit 135 determines the type of notification and the level of notification for the specified first target object. A method of determining the type of notification and the level of notification for the first target object is the same as in the case of detecting one target object as described above.

Next, the notification determination unit 135 specifies a target object with the second highest risk index value next to the first target object among the detected target objects. Such a target object is referred to as a second target object. The notification determination unit 135 determines the type of notification and the level of notification for the specified second target object. At this time, the notification determination unit 135 determines the type of notification and the level of notification to notify of the presence of the second target object such that the level of the notification to notify of the presence of the second target object is lower than the level of the notification to notify of the presence of the first target object.

For example, the notification determination unit 135 determines the types and the number of notifications of the second target object such that the number of types of notifications used to notify of the presence of the second target object is less than the number of types of notifications used to notify of the presence of the first target object. For example, the visual HMI device 310 and the auditory HMI device 330 may be used to notify of the presence of the first target object, and the auditory HMI device 330 may be used to notify of the presence of the second target object. At this time, the HMI devices used to notify of the first target object may be synchronized with each other to allow the driver to recognize the first target object. For example, blinking of the figure displayed on the windshield 3 by the visual HMI device 310 may be synchronized with an output timing of the electronic sound output by the auditory HMI device 330, or a blinking cycle of the figure displayed by the visual HMI device 310 may be synchronized with a period of the vibration output by the tactile HMI device 350. More specifically, a timing of blinking the figure displayed by the visual HMI device 310 may be synchronized with a timing of vibrating the seat by the tactile HMI device 350.

Furthermore, the notification determination unit 135 determines the level of notification for the second target object such that the level of notification for the second target object is lower than the level of notification for the first target object.

The notification determination unit 135 determines a value of a parameter that defines the level of notification for the HMI device 30. At this time, the notification determination unit 135 sets a parameter such that a parameter for defining the level of notification for the first target object is higher than a parameter for defining the level of notification for the second target object.

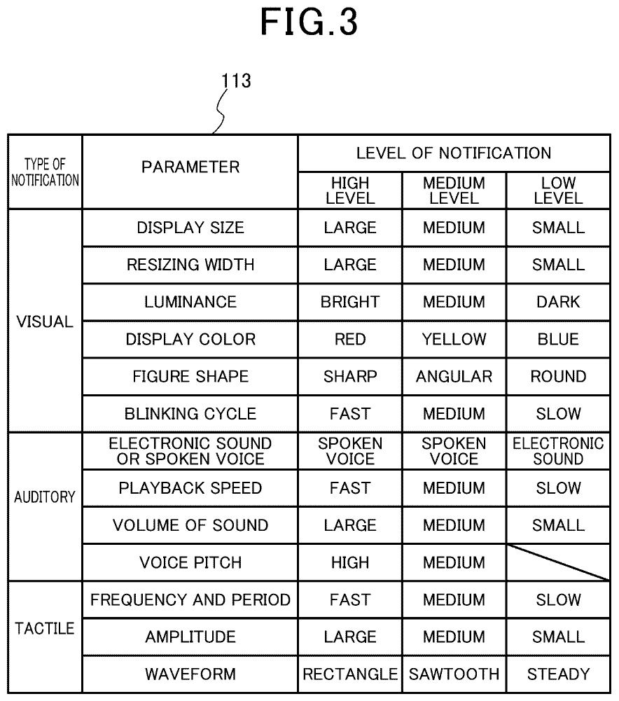

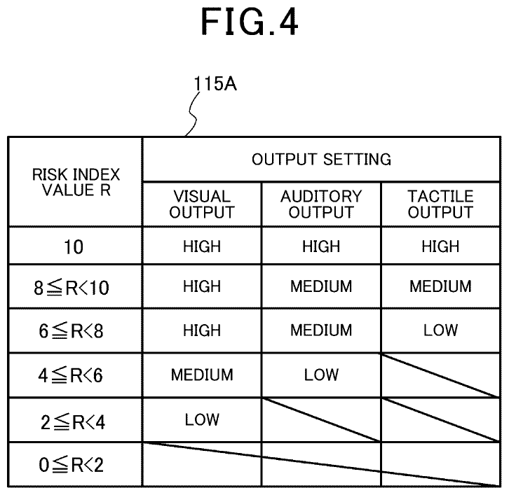

Next, a description will be described with reference to FIGS. 3 and 4 with respect to an operation of the notification determination unit 135 for determining the type of notification and the level of notification.

First, FIGS. 3 and 4 will be described.

FIG. 3 is a diagram illustrating an example of the first setting table 113.

In the first setting table 113, parameters included in each of the visual, auditory, and tactile HMI devices 30 and a setting for each level of notification for each of the parameters are registered in association with each other.

The parameters for changing a state of the figure displayed by the visual HMI device 310 include, for example, a display size, a resizing width, a display color, a figure shape, and a blinking cycle. These parameters correspond to visual parameters. The setting for each level of notification for each of the parameters is registered in the first setting table 113. The levels of notification include a high level of notification, a medium level of notification, and a low level of notification. Hereinafter, the high level of notification is indicated as a high level, the medium level of notification is indicated as a medium level, and the low level of notification is indicated as a low level.

When the parameter is a display size, a display size of “large” is registered as the setting for the high level, a display size of “medium” is registered as the setting for the medium level, and a display size of “small” is registered as the setting for the low level.

When the parameter is a resizing width, “large” is registered as the setting for the high level, “medium” is set as the setting for the medium level, and “small” is registered as the setting for the low level. The resizing width is a size change width by which the display size of the figure displayed by the visual HMI device 310 is enlarged or reduced. For example, when the resizing width is “large”, the size of the figure displayed by the visual HMI device 310 is significantly changed from a “large” to a “small” size and from a “small” size to a “large” size. When the display size of the figure displayed by the visual HMI device 310 is significantly changed in this way to attract the driver's attention.

When the parameter is luminance, luminance of “bright” is registered as the setting for the high level, luminance of “medium” is registered as the setting for the medium level, and luminance of “dark” is registered as the setting for the low level.

When the parameter is a display color, a display color of “red” is registered as the setting for the high level, a display color of “yellow” is registered as the setting for the medium level, and a display color of “blue” is registered as the setting for the low level.

When the parameter is a figure shape, a figure shape of “sharp” is registered as the setting for the high level, a figure shape of “angular” is registered as the setting for the medium level, and a figure shape of “round” is registered as the setting for the low level. The sharper the figure shape displayed by the visual HMI device 310, the higher the degree of risk is recognized, and the rounder the figure shape displayed by the visual HMI device 310, the lower the degree of risk is recognized.

When the parameter is a blinking cycle, a blinking cycle of “fast” is registered as the setting for the high level, a blinking cycle of “medium” is registered as the setting for the medium level, and a blinking cycle of “slow” is registered as the setting for the low level.

Parameters for changing a state of the voice output by the auditory HMI device 330 include, for example, an electronic sound or spoken voice, a playback speed, a volume of sound, and a voice pitch. These parameters correspond to auditory parameters. The setting for each level of notification for each of these parameters is registered in the first setting table 113.

When the parameter is an electronic sound or a spoken voice, the setting for the high level is registered as “spoken voice”, the setting for the medium level is registered as “spoken voice”, and the setting for the low level is registered as “electronic sound”.

When the parameter is a playback speed, a playback speed of “fast” is registered as the setting for the high level, a playback speed of “medium” is registered as the setting for the medium level, and a playback speed of “slow” is registered as the setting for the low level.

When the parameter is a volume of sound, a volume of sound of “large” is registered as the setting for the high level, a volume of sound of “medium” is registered as the setting for the medium level, and a volume of sound of “small” is registered as the setting for the low level.

When the parameter is a voice pitch (tone), a voice pitch of “high” is registered as the setting for the high level, and a voice pitch of “medium” is registered as the setting for the medium level. At the setting for the low level, an electronic sound is output, and thus the voice pitch is not registered.

Parameters for changing a state of the vibration output by the tactile HMI device 350 include, for example, a frequency or a period, an amplitude, a waveform. These parameters correspond to tactile parameters. The setting for each level of notification for each of these parameters is registered in the first setting table 113.

When the parameter is a frequency or a period, the setting for the high level is registered as “fast”, the setting for the medium level is registered as “medium”, and the setting for the low level is registered as “slow”.

When the parameter is an amplitude, the setting for the high level is registered as “large”, the setting for the medium level is registered as “medium”, and the setting for the low level is registered as “small”.

When the parameter is a waveform, the setting for the high level is registered as “rectangle”, the setting for the medium level is registered as “sawtooth”, and the setting for the low level is registered as “steady”.

FIG. 4 is a diagram illustrating an example of the second setting table 115A.

The second setting table 115A is a table in which ranges of the classified risk index values are associated with types of notification and levels of notification in each range. In FIG. 4, the risk index value is represented as a risk index value R.

The ranges of the risk index value R are registered in columns of the second setting table 115A. The second setting table 115A illustrated in FIG. 4 indicates an example in which the risk index value R is classified into six ranges of “R=10”, “8≤R<10”, “6≤R<8”, “4≤R<6”, “2≤R<4”, and “0≤R<2”.

Visual output, auditory output, and tactile output settings are registered in rows of the second setting table 115A. The output settings include settings for the types of notification and the levels of notification used to notify the driver. The settings for the type of notification include visual output, auditory output, and tactile output. The visual output is a notification in the form of the figure displayed by the visual HMI device 310, the auditory output is a notification in the form of a sound output from the auditory HMI device 330, and the tactile output is a notification in the form of the vibration of the seat generated by the tactile HMI device 350. The settings for the level of notification include three stages of “high”, “medium”, and “low”. The level of notification being “high” corresponds to the “high level” illustrated in FIG. 3, the level of notification being “medium” corresponds to the “medium level” illustrated in FIG. 3, the level of notification being “low” corresponds to the “low level” illustrated in FIG. 3.

In the example of the second setting table 115A illustrated in FIG. 4, when the risk index value R is “10”, the visual output, the auditory output, and the tactile output are selected as outputs to be used for notification, and the levels of notification are all set to “high”.

When the risk index value R is “8≤R<10”, visual output, auditory output, and tactile output are selected as outputs to be used for notification, the level of notification of the visual output is set to “high”, and the levels of notification of the auditory output and the tactile output are set to “medium”.

When the risk index value R is “6≤R<8”, visual output, auditory output, and tactile output are selected as outputs to be used for notification, the level of notification of the visual output is set to “high”, the level of notification of the auditory output is set to “medium”, and the level of notification of the tactile output is set to “low”.

When the risk index value R is “4≤R<6”, visual output and auditory output are selected as outputs to be used for notification, the level of notification of the visual output is set to “medium”, and the level of notification of the auditory output is set to “low”. The tactile output is not selected as an output to be used for notification.

When the risk index value R is “2≤R<4”, a visual output is selected as an output to be used for notification, the level of notification of the visual output is set to “low”. The auditory output and the tactile output are not selected as the output to be used for notification.

For example, it is assumed that two target objects of the first target object and the second target object are detected as target objects to be notified. In this case, the notification determination unit 135 refers to the second setting table 115A illustrated in FIG. 4, and determines the level of notification for the second target object such that the level of notification of at least one type of notification used to notify of the second target object with a low risk index value R is lower than the level of notification of at least one type of notification used to notify of the first target object with a high risk index value R.

For example, it is assumed that the risk index value R of the first target object is “10” and the risk index value R of the second target object is “8≤R<10”. In this case, the level of notification of the auditory output for the first target object is set to “high”, and the level of notification of the auditory output for the second target object is set to “medium”.

In addition, it is assumed that the risk index value R of the first target object is “6≤R<8” and the risk index value R of the second target object is “4≤R<6”. In this case, the level of notification of the visual output for the first target object is set to “high”, and the level of notification of the visual output for the second target object is set to “medium”. Moreover, the level of notification of the auditory output for the first target object is set to “medium”, and the level of notification of the auditory output for the second target object is set to “low”.

The notification determination unit 135 determines the type of notification and the level of notification by referring to the second setting table 115A illustrated in FIG. 4, and then acquires parameter values corresponding to the type of notification and the level of notification determined by referring to the first setting table 113 illustrated in FIG. 3. The notification determination unit 135 outputs the determined type of notification and the acquired parameter values to the notification execution unit 137.

For example, when the risk index value R is “8≤R<10”, the types of notification are determined, based on the second setting table 115A illustrated in FIG. 4, to be the visual HMI device 310 and the auditory HMI device 330, and the levels of notification are determined to be the “high” level for the visual HMI device 310 and to be the “medium” level for the auditory HMI device 330.

Next, since the visual HMI device 310 is at the “high” level, the display size “large”, the resizing width “large”, the luminance “bright”, the display color “red”, the figure shape “sharp”, the blinking cycle “fast” are acquired from the first setting table 113 illustrated in FIG. 3.

The notification determination unit 135 outputs these types of notification and the acquired parameter values to the notification execution unit 137.

The type of notification and the parameter are input to the notification execution unit 137 from the notification determination unit 135. The notification execution unit 137 operates the HMI device 30 corresponding to the input type of notification according to the parameter. At this time, when the type of notification includes the visual output, the notification execution unit 137 uses the calibration data 117 to convert coordinates of the captured image of the target object detected by the target object detection unit 131 into coordinates on the windshield 3. The notification execution unit 137 displays a figure corresponding to the level of notification at the converted coordinates on the windshield 3.

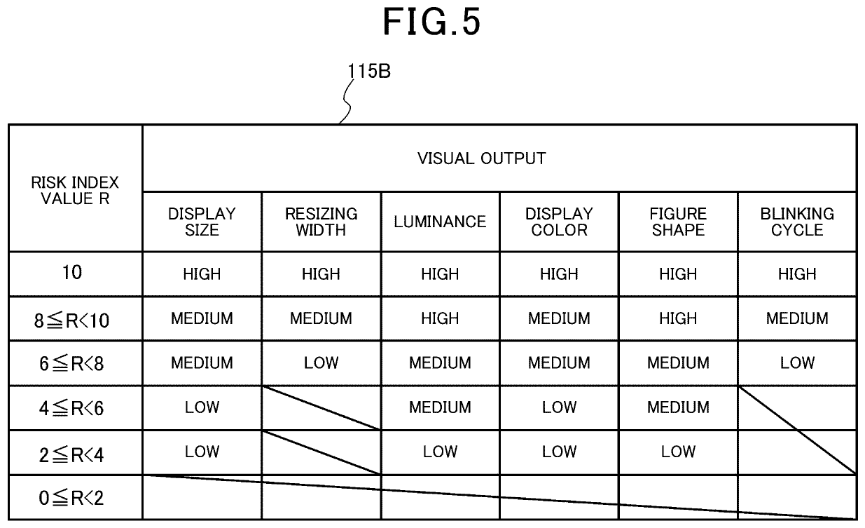

FIG. 5 is a diagram illustrating another example of the second setting table 115.

In a case of setting the type of notification and the level of notification using the first setting table 113 illustrated in FIG. 3 and the second setting table 115A illustrated in FIG. 4, for example, when the level of notification of the visual output is set to “high”, the parameters of the visual HMI device 310, for example, the “display size”, the “resizing width”, the “luminance”, the “display color”, the “figure shape”, and the “blinking cycle” are all set to the “high” level.

The other second setting table 115B illustrated in FIG. 5 is an example in which the values of the parameters of the visual HMI device 310, for example, the “display size”, the “resizing width”, the “luminance”, the “display color”, the “figure shape”, and the “blinking cycle” are changed to different values depending on the range in which the risk index value R falls.

In the other setting table illustrated in FIG. 5, when the risk index value R is “10”, all of the parameters of the “display size”, the “resizing width”, the “luminance”, the “display color”, the “figure shape”, and the “blinking cycle” are set to “high”.

Furthermore, when the range, in which the risk index value R falls, is “8≤R<10”, the parameters of the “luminance” and the “figure shape” are set to “high”, and the parameters of the “display size”, the “resizing width”, the “display color”, and the “blinking cycle” are set to “medium”.

When the range, in which the risk index value R falls, is “6≤R<8”, the parameters of the “display size”, the “luminance”, the “display color”, and the “figure shape” are set to “medium”, and the parameters of the “resizing width”, and the “blinking cycle” are set to “low”.

When the range, in which the risk index value R falls, is “4≤R<6”, the parameters of the “luminance” and the “figure shape” are set to “medium”, and the parameters of the “display size” and the “display color” are set to “low”. In addition, the “resizing width” and the “blinking cycle” are set to not be used. In other words, when the risk index value R is “4≤R<6”, the figure displayed by the visual HMI device 310 remains a constant size without being changed in size and does not blink.

When the range, in which the risk index value R falls, is “2≤R<4”, the parameters of the “display size”, the “luminance”, the “display color”, and the “figure shape” are set to “low”. In addition, the “resizing width” and the “blinking cycle” are set to not be used.

Although not illustrated in the drawings, regarding the auditory HMI device 330, similarly to the case of the visual HMI device 310, the values of the parameters of the auditory HMI device 330, for example, the “electronic sound or spoken voice”, the “playback speed”, the “volume of sound”, and the “voice pitch” may also be changed to different values depending on the range in which the risk index value R falls.

Similarly, regarding the tactile HMI device 350, the parameters of the tactile HMI device 350, for example, the “frequency and cycle”, the “amplitude”, and the “waveform” may also be changed to different values depending on the range in which the risk index value R falls.

In addition, when the risk index value R is a high value, for example, “10” or “8≤R<10”, the level of notification for the parameter included in the visual output may be made to coincide with the level of notification for the parameters included in the auditory output or the tactile output.

For example, the level of notification for the blinking cycle of the figure displayed by the visual HMI device 310 is made to coincide to be a “high” level with the level of notification for the playback speed of the sound output from the auditory HMI device 330, thereby attracting the driver's attention to the target object notified by the visual HMI device 310 and the auditory HMI device 330.

In addition, the level of notification for the blinking cycle of the figure displayed by the visual HMI device 310 is made to coincide to be a “high” level with the level of notification for the amplitude of the seat vibration output from the tactile HMI device 350, thereby attracting the driver's attention to the target object notified by the visual HMI device 310 and the tactile HMI device 350.

The notification determination unit 135 refers to the other setting table illustrated in FIG. 5 to acquire the level of notification for each of the parameters of the “display size”, the “resizing width”, the “luminance”, the “display color”, the “figure shape”, and the “blinking cycle”, and then refers to the first setting table 113 illustrated in FIG. 3 to acquire the value of the parameter corresponding to the level of notification.

Thereafter, the notification determination unit 135 outputs the determined type of notification and the acquired value of the parameter to the notification execution unit 137.

### 5. Notification Example 1

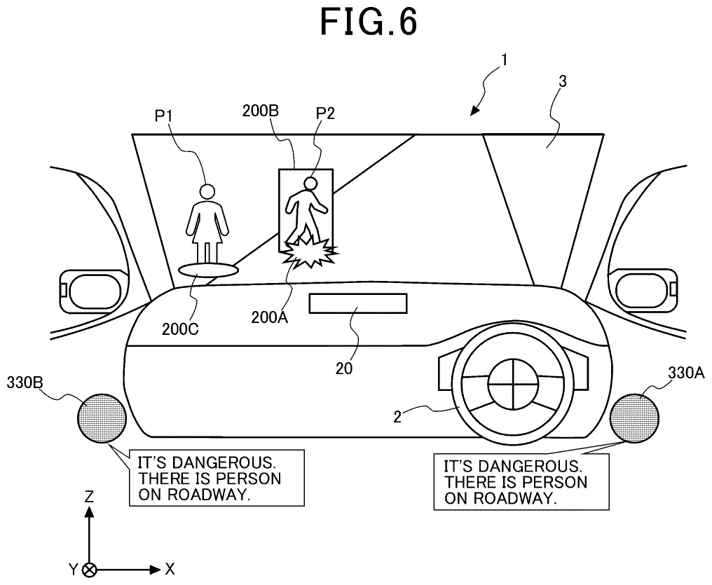

FIG. 6 is a view illustrating a first operation example of the HMI device 30.

The first operation example indicates a case where two persons of a person P1 and a person P2 are detected as target objects. The person P1 is located closer to the vehicle 1 compared to the person P2, but the person P1 is located on a sidewalk rather than a roadway and is in a stopped state. The person P2 is located away from the vehicle 1 compared to the person P1, but the person P2 is located on the roadway and is crossing the roadway. In view of these circumstances, the notification determination unit 135 sets the person P2 as a first target object, and set the person P1 as a second target object.

The attention attracting device 100 displays FIGS. 200A and 200B around the person P2 which is the first target object. The FIG. 200A is a figure displayed under the feet of the person P2, and the FIG. 200B is a figure surrounding the person P2. The attention attracting device 100 also displays a FIG. 200C under the feet of the person P1. When the person P1 and the person P2 are detected from an image captured by the camera, the attention attracting device 100 uses the calibration data 117 to convert the positions of the person P1 and the person P2 in the captured image into positions on the windshield 3. The attention attracting device 100 displays the FIGS. 200A, 200B, and 200C at the converted positions of the person P1 and the person P2 on the windshield 3.

The FIG. 200A displayed under the feet of the person P2, which is the first target object, is sharp in the figure shape (level of notification: high), whereas the FIG. 200C displayed under the feet of the person P1, which is the second target object, is round in the figure shape (level of notification: low). In addition, the FIG. 200A displayed under the feet of the person P2, which is the first target object, quickly blinks (level of notification: high), whereas the FIG. 200C displayed under the feet of the person P1, which is the second target object, does not blink. This makes the driver possible to attract more attention to the person P2 than to the person P1.

In addition, the auditory HMI device 330 outputs a spoken voice to notify the driver that there is a person on the roadway. For example, a voice guidance such as “It's dangerous. There is a person on the roadway” is output. The level of notification of the playback speed of such a voice guidance (level of notification: high) is made to coincide with the level of notification of the blinking speed of the FIG. 200A (level of notification: high), thereby attracting the driver's attention to the person P2.

### 6. Notification Example 2

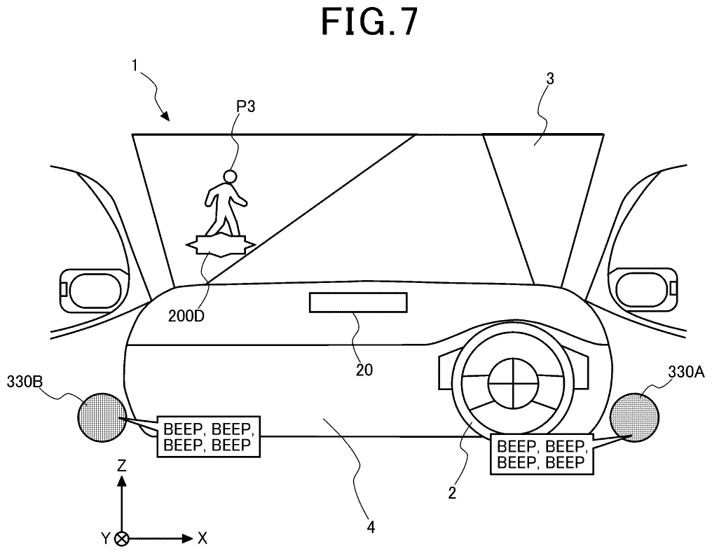

FIG. 7 is a view illustrating a second operation example of the HMI device 30.

The second operation example indicates a case where a person P3 is detected as a target object.

The attention attracting device 100 determines, based on a moving direction of the person P3, that there is a possibility that the person P3 will run out onto the roadway. For this reason, the attention attracting device 100 displays a FIG. 200D under the feet of the person P3, and outputs an electronic sound indicating a warning from the auditory HMI device 330. For example, the attention attracting device 100 sets the level of notification of the electronic sound of “beep, beep, beep, beep, beep” as a notification sound indicating a warning to “high”, and outputs it to auditory HMI device 330. Furthermore, the attention attracting device 100 sets the level of notification of the FIG. 200D to “high” and blinks it according to an output timing of the electronic sound. The level of notification of the electronic sound output by the auditory HMI device 330 (level of notification: high) is set to be equal to the level of notification of the blinking speed of the FIG. 200A displayed by the visual HMI device 310 (level of notification: high), thereby attracting the driver's attention to the person P3.

### 7. Notification Example 3

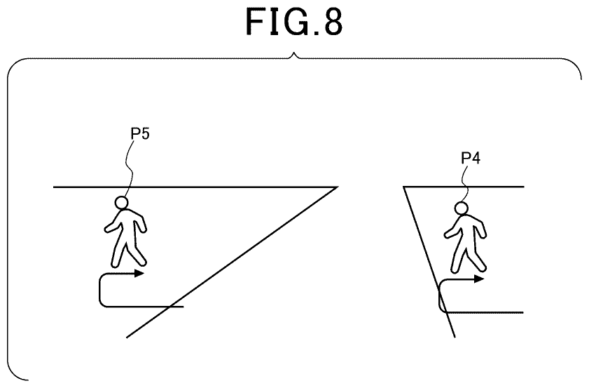

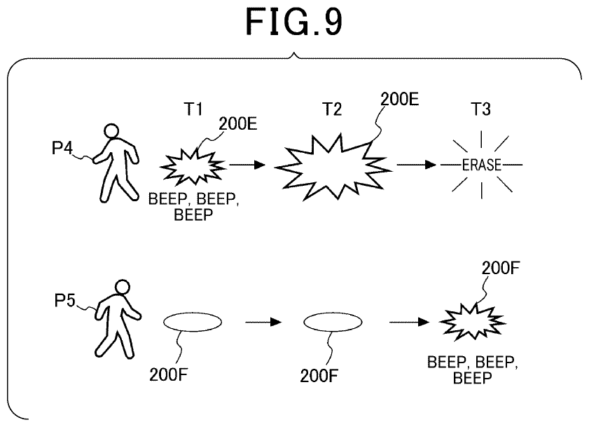

FIGS. 8 and 9 are views illustrating a third operation example of the HMI device 30.

FIG. 8 illustrates a state in which a person P4 and a person P5 walking near the roadway are detected as target objects. A distance between the person P4 and the roadway is shorter than a distance between the person P5 and the roadway, the person P4 walks in a direction approaching the roadway, and the person P5 walks in a direction away from the roadway. Therefore, the attention attracting device 100 sets the person P4 as a first target object and sets the person P5 as a second target object to start attention attracting.

FIG. 9 is a view illustrating changes in attention attracting, which is output by the attention attracting device 100.

It is assumed that the timing when the attention attracting device 100 sets the persons P4 and P5 as the target objects is time T1. At time T1, the attention attracting device 100 displays a FIG. 200E blinking under the feet of the person P4, and outputs an electronic sound from the auditory HMI device 330 in synchronization with the blinking of the FIG. 200E. In other words, the timing of the blinking of the FIG. 200E synchronizes with the timing of the output of the electronic sound “beep”. At this time, the level of notification of the electronic sound output by the auditory HMI device 330 may be set to be equal to the level of notification of the blinking speed of the FIG. 200E displayed by the visual HMI device 310, thereby attracting the driver's attention to the person P4.

Furthermore, at time T1, the attention attracting device 100 displays a FIG. 200F under the feet of the person P4. The FIG. 200F does not blink like the FIG. 200E.

Next, it is assumed that, at time T2, the person P4 makes a U-turn and starts walking in the direction away from the roadway. As the person P4 starts walking in the direction away from the roadway, the risk index value R of the person P4 decreases and, the risk index value of the person P4 becomes lower than the risk index value of the person P5. At this time, the risk index value R of the person P4 becomes lower than the first threshold value and is assumed to be no longer a notification target.

When the risk index value R of the person P4 is no longer a notification target, the attention attracting device 100 changes the level of notification of any one of the types of notification for the person P4 to be high or low, and then allows the HMI device 30 to stop the notification for the person P4. For example, the attention attracting device 100 largely changes the display size of the FIG. 200E displayed by the visual HMI device 310 and being one of the types of notification for the person P4 which is the first target object, and then allows all of the HMI devices 30 to stop the notification for the person P4. In other words, the attention attracting device 100 erases the FIG. 200E displayed by the visual HMI device 310, and stops the electronic sound output by the auditory HMI device 330. Here, a case is shown where the display size of the FIG. 200E is largely changed, but the display size of the FIG. 200E may be small changed.

Furthermore, when the risk index value R of the person P4 is no longer a notification target, the attention attracting device 100 changes a level of a first type of notification among the types of notifications for the person P4 to be high, changes a level of a second type of notification different from the first type to be low, and then allows the HMI device 30 to stop the notification for the person P4. For example, after largely changing the electronic sound output by the auditory HMI device 330 and small changing the display size of the FIG. 200E displayed by the visual HMI device 310, the attention attracting device 100 may erase the FIG. 200E displayed by the visual HMI device 310 and stop the electronic sound output by the auditory HMI device 330.

Next, it is assumed that, at time T3, the person P5 makes a U-turn and starts walking in the direction approaching the roadway. As the person P5 starts walking in the direction approaching the roadway, the risk index value R of the person P5 increases and the risk index value of the person P5 becomes higher than the risk index value of the person P4. At this time, the attention attracting device 100 changes a level of notification for the person P5 to be higher than the level of notification at time T2. Thus, for example, the display size of the FIG. 200F displayed under the feet of the person P5 becomes larger than that at time T2. Then, when the person P5 approaches the roadway and the risk index value of the person P5 increases, the attention attracting device 100 starts outputting the electronic sound in addition to the display of the FIG. 200F.

### 8. Operation of Attention Attracting Device

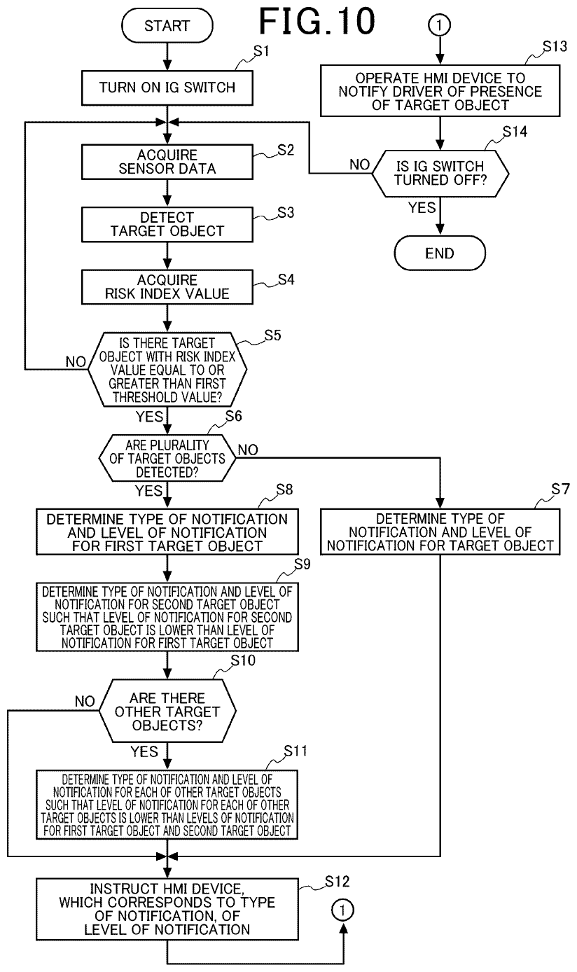

FIG. 10 is a flowchart illustrating an operation of the attention attracting device 100.

The operation of the attention attracting device 100 will be described with reference to the flowchart illustrated in FIG. 10.

First, when an IG switch of the vehicle is turned on (step S1), the attention attracting device 100 is started to acquire sensor data from the vehicle sensor 10 (step S2).

Next, the attention attracting device 100 detects a target object present around the vehicle 1 based on the sensor data (step S3), and detects a position, a moving speed, and a moving direction of the detected target object.

Next, the attention attracting device 100 acquires a risk index value of the detected target object (step S4). The attention attracting device 100, for example, scores the position, the traveling direction, and the moving speed of the target object, and the distance between the vehicle 1 and the target object, and multiplies the scored values by a weighting coefficient to calculate the sum of these values as the risk index value.

Next, the attention attracting device 100 determines whether the acquired risk index value is equal to or greater than a first threshold value set in advance (step S5). When the attention attracting device 100 determines that the risk index value is not equal to or greater than the first threshold value (NO in step S5), the process returns to step S2.

Next, when the risk index value is equal to or greater than the first threshold value (YES in step S5), the attention attracting device 100 determines whether a plurality of target objects with the risk index value equal to or greater than the first threshold value are detected (step S6).

When the plurality of target objects are not detected (NO in step S6), the attention attracting device 100 determines a type of notification and a level of notification based on the risk index values of the detected target objects (step S7).

Furthermore, when the plurality of target objects are detected (YES in step S6), first, the attention attracting device 100 determines a type of notification and a level of notification for a first target object (step S8). The first target object is a target object with the highest risk index value among the detected target objects.

Next, the attention attracting device 100 determines a type of notification and a level of notification for a second target object (step S9). The second target object is a target object with the second highest risk index value next to the first target objects.

The attention attracting device 100 determines the type of notification and the level of notification for the second target object such that the level of notification for the second target object is lower than the level of notification for the first target object set in step S7 (step S9).

Next, the attention attracting device 100 determines whether there are target objects other than the first target object and the second target object among the target objects detected in step 5 (step S10).

When there are target objects other than the first target object and the second target object (YES in step S10), the attention attracting device 100 determines a type of notification and a level of notification for each of the other target objects such that the levels of notification for the other target objects are lower than the levels of notification for the first target object and the second target object set in steps S7 and S8 (step S11). In addition, when there are a plurality of target objects as the other target objects, the attention attracting device 100 determines a type of notification and a level of notification for each of the other target objects to be lower than the levels of notification for the target objects, which are already determined, similarly to steps S7 and S8.

When there are no target objects other than the first target object and the second target object (NO in step S10) and when the type of notification and the level of notification for each of the other target objects are set in step S11, the attention attracting device 100 instructs the HMI device 30, which corresponds to the type of notification, of the level of notification (step S12).

Next, the attention attracting device 100 operates the HMI device 30 at the determined level of notification to notify the driver of the presence of the target object (step S13).

Next, the attention attracting device 100 determines whether an IG key of the vehicle 1 is turned off (step S14). When the attention attracting device 100 determines that the IG key of the vehicle 1 is not turned off (NO in step S14), the process returns to step S2. When the attention attracting device 100 determines that the IG key of the vehicle 1 is turned off (YES in step S14), the processing flow is ended.

### 9. Other Embodiments

The above-embodiment is merely one aspect, and may be arbitrarily changed and applicable.

The case has been described in the above-described embodiment in which the visual HMI device 310 is a HUD, but the visual HMI device 310 may also be display means, for example, a light emitting diode (LED).

Moreover, respective components of the vehicle 1 illustrated in FIG. 1 are an example, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, the step units of the operations illustrated in FIG. 10 are divided according to the main processing contents, and the present invention is not limited by the manner in which the processing units are divided or the names of the processing units. Depending on the processing contents, the process may be divided into more step units. Further, one step unit may be divided so as to include more processing. In addition, the order of the steps may be changed as appropriate within the scope of the present invention.

Furthermore, when the attention attracting method using of the above-described attention attracting device 100 is to be implemented using the processor 130, the program to be executed by the processor 130 can be configured with a mode of recording medium or a mode of transmission medium that transmits the program. In other words, the control program 111 can also be implemented in a state where the control program 111 is recorded on a portable information recording medium. Examples of the information recording medium may include a magnetic recording medium such as a hard disk, an optical recording medium such as a CD, and semiconductor memory devices such as a USB (Universal Serial Bus) memory and an SSD (Solid State Drive), but other recording media can also be used.

### 10. Configuration Supported by Embodiment

The above-described embodiment supports the following configurations.

### Configuration 1

An attention attracting device includes: an index value acquisition unit that acquires, based on outputs of a plurality of sensors mounted on a vehicle, a risk index value indicating a collision risk with a target object present in front of the vehicle; a determination unit that, when a target object is detected of which the acquired risk index value is within a setting range set in advance, determines types of notification to be notified to a driver of the vehicle by an HMI device and a level of notification for each of the types of notification, based on the risk index value; and a notification execution unit that causes the HMI device corresponding to the type of notification determined by the determination unit to notify the driver of the vehicle at the level of notification determined by the determination unit, the determination unit being configured to determine, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

According to the attention attracting device of Configuration 1, when the plurality of target objects with the risk index values within the setting range are detected, the level of notification for the target object with the low risk index value is determined such that the level of notification corresponding to at least one type of notification used to notify of the target object with the low risk index value is lower than the level of notification corresponding to at least one type of notification used to notify of the target object with the high risk index value. Therefore, when the plurality of target object to be notified are detected, it is possible to notify the driver of the presence of the plurality of target objects and to notify the driver of the first target object that requires the most attention.

### Configuration 2

In the attention attracting device according to Configuration 1, the determination unit is configured to: detect, as the plurality of target objects, a first target object with the risk index value within the setting range and a second target object with the risk index value within the setting range, the risk index value being smaller than the risk index value of the first target object; and when the risk index value of the first target object falls below the setting range, change the level of notification of any one of types of notification for the first target object to be high or low, and then allow the HMI device to stop the notification for the first target object.

According to the attention attracting device of Configuration 2, when the risk index value of the first target object falls below the setting range, the level of notification of any one of the types of notification for the first target object is changed to be high or low, and then the notification for the first target object by the HMI device is stopped. This makes it possible to attract the driver's attention to the first target object and to make the driver recognize that the first target object has become a target with the low risk index value.

### Configuration 3

In the attention attracting device according to Configuration 1, the determination unit is configured to: detect, as the plurality of target objects, a first target object with the risk index value within the setting range and a second target object with the risk index value within the setting range, the risk index value being smaller than the risk index value of the first target object; and when the risk index value of the first target object falls below the setting range, change a level of a first type of notification among types of notifications used for the first target object to be high, change a level of a second type of notification different from the first type to be low, and then allow the HMI device to stop the notification for the first target object.

According to the attention attracting device of Configuration 3, when the risk index value of the first target object falls below the setting range, the level of the first type of notification among the types of notifications used for the first target object is changed to be high, the level of the second type of notification different from the first type is changed to be low, and then the notification for the first target object by the HMI device is stopped. This makes it possible to attract the driver's attention to the first target object and to make the driver recognize that the first target object has become a target with the low risk index value.

### Configuration 4

In the attention attracting device according to Configuration 1, the HMI device includes a visual HMI device, the determination unit is configured to determine a value of a visual parameter for changing an image displayed by the visual HMI device from the level of notification determined based on the risk index value, and the visual parameter includes a parameter for changing at least one of enlargement and reduction of the image, a display area of the image, display luminance of the image, a color of the image, a shape of the image, and a blinking cycle of the image.

According to the attention attracting device of Configuration 4, the value of the visual parameter is determined according to the level of notification that is determined based on the risk index value. Therefore, at least one of the enlargement and reduction of the image displayed by the visual HMI device, the display area of the image, the display luminance of the image, the color of the image, the shape of the image, and the blinking cycle of the image can be changed corresponding to the level of notification.

### Configuration 5

In the attention attracting device according to Configuration 1, the HMI device includes an auditory HMI device, the determination unit is configured to determine a value of an auditory parameter for changing a voice output by the auditory HMI device from the level of notification determined based on the risk index value, and the auditory parameter includes a parameter for changing at least one of a playback speed or a playback cycle, a volume of sound, and a voice pitch of voice data which is a source of the voice.

According to the attention attracting device of Configuration 5, the value of the auditory parameter is determined according to the level of notification that is determined based on the risk index value. Therefore, at least one of the playback speed or the playback cycle, the volume of sound, and the voice pitch of voice data, which is a source of the voice output by the auditory HMI device, can be changed corresponding to the level of notification.

### Configuration 6

In the attention attracting device according to Configuration 1, the HMI device includes a tactile HMI device, the determination unit is configured to determine a value of a tactile parameter for changing a level of vibration output by the tactile HMI device from the level of notification determined based on the risk index value, and the tactile parameter includes a parameter for changing at least one of a period of the vibration, an amplitude of the vibration, and a waveform of the vibration.

According to the attention attracting device of Configuration 6, the value of the tactile parameter is determined according to the level of notification that is determined based on the risk index value. Therefore, at least one of the period of the vibration, the amplitude, and the waveform of the vibration output by the tactile HMI device can be changed corresponding to the level of notification.

### Configuration 7

An attention attracting method of causing a processor of an attention attracting device mounted on a vehicle to execute: an acquisition step of acquiring, based on outputs of a plurality of sensors mounted on a vehicle, a risk index value indicating a collision risk with a target object present in front of the vehicle; a determination step of, when a target object is detected of which the acquired risk index value is within a setting range set in advance, determining types of notification to be notified to a driver of the vehicle by an HMI device and a level of notification for each of the types of notification, based on the risk index value; and a notification step of causing the HMI device corresponding to the type of notification determined in the determination step to notify the driver of the vehicle at the level of notification determined in the determination step, the determination step including determining, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

According to the attention attracting device of Configuration 7, when the plurality of target objects with the risk index values within the setting range are detected, the level of notification for the target object with the low risk index value is determined such that the level of notification corresponding to at least one type of notification used to notify of the target object with the low risk index value is lower than the level of notification corresponding to at least one type of notification used to notify of the target object with the high risk index value. Therefore, when the plurality of target object to be notified are detected, it is possible to notify the driver of the presence of the plurality of target objects and to notify the driver of the first target object that requires the most attention.

### REFERENCE SIGNS LIST

1 vehicle
3 windshield
4 instrument panel
10 vehicle sensor
30 HMI device
50 vehicle control device
100 attention attracting device
110 storage unit
111 control program
113 first setting table
115A, 115B second setting table
117 calibration data
130 processor
131 target object detection unit
133 risk index value acquisition unit
135 notification determination unit
137 notification execution unit
200C person figure
310 visual HMI device
330A speaker
330B speaker
330 auditory HMI device
350 tactile HMI device

1. An attention attracting device comprising:
an index value acquisition unit that acquires, based on outputs of a plurality of sensors mounted on a vehicle, a risk index value indicating a collision risk with a target object present in front of the vehicle;
a determination unit that, when a target object is detected of which the acquired risk index value is within a setting range set in advance, determines types of notification to be notified to a driver of the vehicle by an HMI device and a level of notification for each of the types of notification, based on the risk index value; and
a notification execution unit that causes the HMI device corresponding to the type of notification determined by the determination unit to notify the driver of the vehicle at the level of notification determined by the determination unit,
the determination unit being configured to determine, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.

2. The attention attracting device according to claim 1, wherein
the determination unit is configured to:
detect, as the plurality of target objects, a first target object with the risk index value within the setting range and a second target object with the risk index value within the setting range, the risk index value being smaller than the risk index value of the first target object; and
when the risk index value of the first target object falls below the setting range, change the level of notification of any one of types of notification for the first target object to be high or low, and then allow the HMI device to stop the notification for the first target object.

3. The attention attracting device according to claim 1, wherein
the determination unit is configured to:
detect, as the plurality of target objects, a first target object with the risk index value within the setting range and a second target object with the risk index value within the setting range, the risk index value being smaller than the risk index value of the first target object; and
when the risk index value of the first target object falls below the setting range, change a level of a first type of notification among types of notifications used for the first target object to be high, change a level of a second type of notification different from the first type to be low, and then allow the HMI device to stop the notification for the first target object.

4. The attention attracting device according to claim 1, wherein
the HMI device includes a visual HMI device,
the determination unit is configured to determine a value of a visual parameter for changing an image displayed by the visual HMI device from the level of notification determined based on the risk index value, and
the visual parameter includes a parameter for changing at least one of enlargement and reduction of the image, a display size of the image, display luminance of the image, a display color of the image, a shape of the image, and a blinking cycle of the image.

5. The attention attracting device according to claim 1, wherein
the HMI device includes an auditory HMI device,
the determination unit is configured to determine a value of an auditory parameter for changing a voice output by the auditory HMI device from the level of notification determined based on the risk index value, and
the auditory parameter includes a parameter for changing at least one of a playback speed or a playback cycle, a volume of sound, and a voice pitch of voice data which is a source of the voice.

6. The attention attracting device according to claim 1, wherein
the HMI device includes a tactile HMI device,
the determination unit is configured to determine a value of a tactile parameter for changing a level of vibration output by the tactile HMI device from the level of notification determined based on the risk index value, and
the tactile parameter includes a parameter for changing at least one of a period of the vibration, an amplitude of the vibration, and a waveform of the vibration.

7. An attention attracting method of causing a processor of an attention attracting device mounted on a vehicle to execute:
an acquisition step of acquiring, based on outputs of a plurality of sensors mounted on a vehicle, a risk index value indicating a collision risk with a target object present in front of the vehicle;
a determination step of, when a target object is detected of which the acquired risk index value is within a setting range set in advance, determining types of notification to be notified to a driver of the vehicle by an HMI device and a level of notification for each of the types of notification, based on the risk index value; and
a notification step of causing the HMI device corresponding to the type of notification determined in the determination step to notify the driver of the vehicle at the level of notification determined in the determination step,
the determination step including
determining, when a plurality of target objects with the risk index value within the setting range are detected, a level of notification for a target object with the risk index value being low such that a level of notification corresponding to at least one type of notification used to notify of the target object with the risk index value being low is lower than the level of notification corresponding to at least one type of notification used to notify of a target object with the risk index value being high.
